(19) United States
(12) Patent Application Publication
(10) Pub. No.: US 2026/0138623 A1
(43) Pub. Date: May 21, 2026

(54) METHOD AND APPARATUS FOR ADJUSTING VEHICLE ENVIRONMENT

(71) Applicant: HYUNDAI AUTOEVER CORP., Seoul (KR)

(72) Inventor: Se Yeong Bae, Seoul (KR)

(73) Assignee: HYUNDAI AUTOEVER CORP., Seoul (KR)

(21) Appl. No.: 19/349,795

(22) Filed: Oct. 3, 2025

(30) Foreign Application Priority Data
Nov. 20, 2024 (KR) 10-2024-0165808

(51) Int. Cl. B60W 50/00; B60W 30/182; B60W 50/14

(52) U.S. Cl. CPC B60W 50/0098; B60W 30/182; B60W 50/14; B60W 2050/0083; B60W 2050/146; B60W 2540/01; B60W 2556/40

(57) ABSTRACT

A method for adjusting a vehicle environment, performed by a navigation device, includes acquiring information on a location associated with a vehicle in which the navigation device is provided. The method also includes determining whether an infant is on board the vehicle based on the information on the location associated with the vehicle. The method additionally includes, in response to determining that an is board the vehicle, activating an infant boarding mode for the vehicle.

### CROSS-REFERENCE TO RELATED APPLICATION

This application claims the benefit of and priority to Korean Patent Application No. 10-2024-0165808, filed on Nov. 20, 2024, the entire contents of which are hereby incorporated herein by reference.

### TECHNICAL FIELD

The present disclosure relates to a method and apparatus for adjusting a vehicle environment.

### BACKGROUND

The statements in this section merely provide background information related to the present disclosure and may not constitute prior art.

As vehicle usage increases, the number of cases involving infants on board is also increasing, and accordingly, situations where music or videos need to be played for infants in vehicles are becoming more frequent.

However, playing music or videos while driving requires operating a separate device such as a mobile device or CarPlay, or manipulating the vehicle's display, which may pose a safety risk. Additionally, when an infant falls asleep during driving, it is difficult to stop or turn off the music or video currently being played.

### SUMMARY

Aspects of the present disclosure provide a method and an apparatus configured to safely control the in-vehicle environment for infants even while driving a vehicle.

Aspects of the present disclosure provide a method and an apparatus for effectively detecting whether an infant is on board a vehicle and controlling (e.g., automatically controlling) the in-vehicle environment accordingly.

Aspects of the present disclosure provide a method and an apparatus for effectively detecting the state of an infant in a vehicle and controlling (e.g., automatically controlling) the in-vehicle environment accordingly.

The objectives of the present disclosure are not limited to those mentioned above. Other objectives not explicitly stated herein should be more clearly understood by those having ordinary skill in the art from the following description.

According to an aspect of the present disclosure, a method for adjusting a vehicle environment is provided. The method may be performed by a navigation device. The method includes acquiring information on a location associated with a vehicle in which the navigation device is provided. The method also includes determining whether an infant is on board the vehicle based on the information on the location associated with the vehicle. The method additionally includes, in response to determining that an infant is on board the vehicle, activating an infant boarding mode for the vehicle. Determining whether an infant is on board the vehicle includes determining whether the location associated with the vehicle is an infant-related place.

In some embodiments, the location associated with the vehicle may include a destination of the vehicle, and the acquiring of the information on the location associated with the vehicle may comprise acquiring information on the destination of the vehicle using route guidance information of the vehicle.

In some embodiments, the location associated with the vehicle may include a departure point of the vehicle, and the acquiring of the information on the location associated with the vehicle may comprise acquiring information on the departure point of the vehicle using route guidance information of the vehicle.

In some embodiments, determining whether the location is an infant-related place may include acquiring information on a place category of the location associated with the vehicle, and determining whether the place category of the location associated with the vehicle is included in a preset infant-related place category.

In some embodiments, the preset infant-related place category may include at least one of a pediatric clinic, emergency room, daycare center, kids café, kindergarten, children's museum, or children-only theater.

In some embodiments, activating the infant boarding mode may include providing, on a display of the navigation device, a screen for confirming whether to activate the infant boarding mode.

In some embodiments, activating the infant boarding mode may include adjusting settings of the navigation device to correspond to the infant boarding mode.

In some embodiments, adjusting the settings of the navigation device may include changing a map theme of the navigation device to a map theme provided for infants.

In some embodiments, adjusting the settings of the navigation device may comprise changing a priority of route guidance options of the navigation device.

According to the aforementioned and other embodiments of the present disclosure, a method for adjusting a vehicle environment is provided. The method may be performed by a navigation device. The method includes detecting an infant-related sound in a vehicle in which the navigation device is provided. The method also includes activating a first mode of an infant boarding mode for the vehicle based on detecting the infant-related sound. The method additionally includes, in response to the first mode being activated, adjusting an in-vehicle environment to a state corresponding to the first mode.

In some embodiments, activating the first mode may include providing, on a display of the navigation device, a screen for confirming whether to activate the first mode.

In some embodiments, providing the screen may include acquiring driving state information of the vehicle, and determining whether to provide the screen based on the driving state information of the vehicle.

In some embodiments, adjusting the in-vehicle environment may include providing infant-related media content in the vehicle.

In some embodiments, the method may further comprise activating a second mode different from the first mode when the infant-related sound is not detected for a preset period of time, and, in response to the second mode being activated, generating a control signal for adjusting the in-vehicle environment to a state corresponding to the second mode.

In some embodiments, activating the second mode may include providing, on a display of the navigation device, a screen for confirming whether to activate the second mode.

In some embodiments, providing the screen may include acquiring driving state information of the vehicle, and determining whether to provide the screen based on the driving state information of the vehicle.

In some embodiments, generating the control signal may include generating a first control signal for stopping provision of infant-related media content when the infant-related media content is being provided in the vehicle.

In some embodiments, generating the control signal may include generating a second control signal for adjusting a brightness level of a rear-seat light in the vehicle to a preset value or lower.

In some embodiments, generating the control signal may include generating a third control signal for adjusting a power curtain installed in a rear seat of the vehicle.

According to the aforementioned and other embodiments of the present disclosure, a navigation device is provided. The navigation device comprises a processor and a memory configured to store computer-readable instructions. The computer-readable instructions, when executed by the processor, cause the processor to perform acquire information on a location associated with a vehicle in which the navigation device is provided, determine whether an infant is on board the vehicle based on the information on the location associated with the vehicle, and in response to determining that an infant is on board the vehicle, activate an infant boarding mode for the vehicle. Determining whether an infant is on board the vehicle includes determining whether the location associated with the vehicle is an infant-related place.

According to the aforementioned and other embodiments of the present disclosure, a navigation device is provided. The navigation device comprises a processor and a memory configured to store computer-readable instructions. The computer-readable instructions, when executed by the processor, cause the processor to detect an infant-related sound in a vehicle in which the navigation device is provided, activating a first mode of an infant boarding mode for the vehicle based on detecting the infant-related sound, and, in response to the first mode being activated, adjust an in-vehicle environment to a state corresponding to the first mode.

### BRIEF DESCRIPTION OF THE DRAWINGS

The above and other aspects and features of the present disclosure should become more apparent from the following detailed taken in conjunction with the accompanying drawings, in which:

FIG. 1 is a block diagram illustrating the configuration of a system in which a method for adjusting a vehicle environment, according to some embodiments of the present disclosure may be performed;

FIG. 2 is a flowchart illustrating a vehicle environment adjustment method, according to an embodiment of the present disclosure;

FIG. 3 is a flowchart illustrating a step or operation of acquiring information on a location in the vehicle environment adjustment method of FIG. 2 in more detail, according to an embodiment of the present disclosure;

FIG. 4 is a flowchart illustrating a step or operation of determining whether a location associated with a vehicle is an infant-related place in the vehicle environment adjustment method of FIG. 2, according to an embodiment of the present disclosure;

FIG. 5 is a diagram illustrating an example screen provided to a navigation device, according to some embodiments of the present disclosure;

FIGS. 6 and 7 are flowcharts illustrating a method for adjusting a vehicle environment, according to another embodiment of the present disclosure;

FIG. 8 is a diagram illustrating an example screen provided to a navigation device, according to some embodiments of the present disclosure;

FIG. 9 is a flowchart illustrating step or operation of adjust the in-vehicle environment in the method of FIGS. 6 and 7, according to an embodiment of the present disclosure; and

FIG. 10 is a block diagram illustrating the hardware configuration of a computing device, according to some embodiments of the present disclosure.

### DETAILED DESCRIPTION

Hereinafter, embodiments of the present disclosure are described in detail with reference to the accompanying drawings. Advantages and features of the present disclosure and methods of accomplishing the same should be more clearly understood from the following detailed description of embodiments and the accompanying drawings. The present disclosure may, however, be embodied in many different forms and should not be construed as being limited to the embodiments set forth herein. Rather, these embodiments are provided to make this disclosure thorough and complete and to fully convey the concept of the disclosure to those having ordinary skill in the art. The present disclosure is defined by the appended claims and equivalents thereof.

In adding reference numerals to the components of each drawing, it should be noted that the same reference numerals are assigned to the same components as much as possible even when the components are shown in different drawings. In addition, in the following description, where it was determined that a detailed description of the related well-known configuration or function would obscure the gist of the present disclosure, the detailed description thereof has been omitted.

Unless otherwise defined, all terms used in the present specification (including technical and scientific terms) are used in a sense that can be commonly understood by those having ordinary skill in the art. In addition, the terms defined in the commonly used dictionaries should not be ideally or excessively interpreted unless the terms are specifically defined clearly herein. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are merely for distinguishing the components from other components, and the nature or order of the components is not limited by the terms. If a component is described as being “connected,” “coupled” or “contacted” to another component, that component may be directly connected to or contacted with that other component, but it should be understood that one or more other components also may be “connected,” “coupled” or “contacted” between the two components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

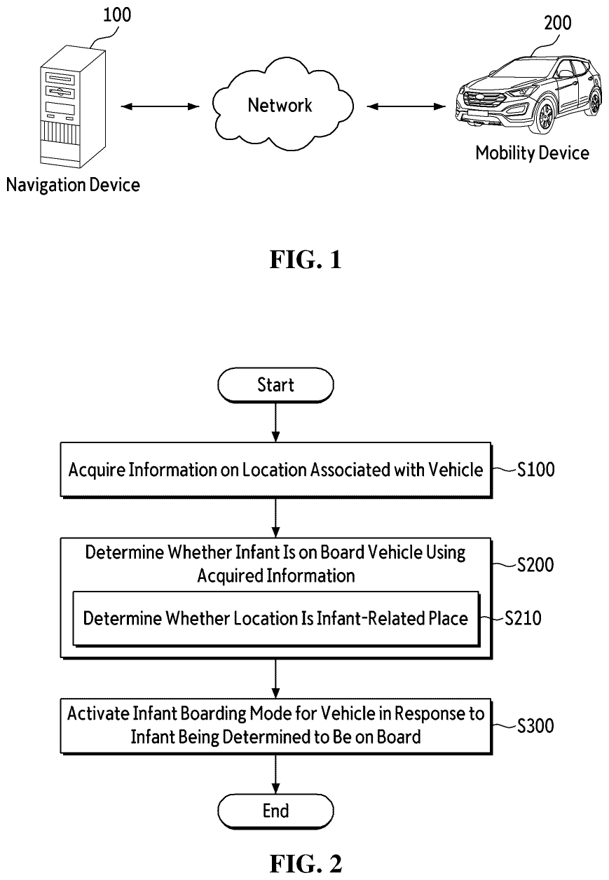

FIG. 1 is a block diagram illustrating the configuration of a system in which a method for adjusting a vehicle environment according to some embodiments of the present disclosure may be performed.

Referring to FIG. 1, the system may include a navigation device 100 and a mobility device 200.

Although the navigation device 100 and the mobility device 200 are illustrated in FIG. 1 as separate systems, in some embodiments, the navigation device 100 and the mobility device 200 may be configured in a stand-alone configuration within a single system. In this case, operations performed by the navigation device 100 may be understood as being performed by the mobility device 200. For convenience of explanation, the mobility device 200 is assumed to be a vehicle, but the present disclosure is not limited thereto.

According to an embodiment of the present disclosure, the navigation device 100 may acquire information on a location associated with a vehicle in which the navigation device 100 is provided. The navigation device 100 may determine whether an infant is on board the vehicle based on the information on the location associated with the vehicle. In an embodiment, the navigation device 100 may determine whether the location associated with the vehicle is an infant-related place. In an embodiment, based on determining that the location associated with the vehicle is an infant-related place, the navigation device 100 may determine that an infant is on board the vehicle. Otherwise, the navigation device 100 may determine that there is no infant on board the vehicle.

Additionally, in response to determining that an infant is on board the vehicle, the navigation device 100 may activate an infant boarding mode for the vehicle. In an embodiment, the infant boarding mode may refer to a function for adjusting the in-vehicle environment for the safety and convenience of the on-board infant. For example, when an infant is on board, the navigation device 100 may generate a signal for controlling various devices and functions of the vehicle to optimize the in-vehicle environment for the on-board infant.

According to an embodiment of the present disclosure, the navigation device 100 may detect an infant-related sound in the vehicle in which the navigation device 100 is provided, and based on detecting an infant-related sound, may activate a first mode of the infant boarding mode for the vehicle. In an embodiment, the first mode may be a sub-mode of the infant boarding mode that is set according to the state of the on-board infant. The first mode may provide a function for optimizing the vehicle environment when the on-board infant is active. The first mode may be referred to as an “active mode,” “play mode,” etc. In some embodiments, the first mode may be the default mode of the infant boarding mode. In this case, when the infant boarding mode is activated, the first mode may be automatically activated.

In response to the activation of the first mode, the navigation device 100 may adjust the in-vehicle environment to a state corresponding to the first mode. For example, the navigation device 100 may provide media infant-related content in the vehicle to adjust the in-vehicle environment to the state corresponding to the first mode.

Additionally, if an infant-related sound is not detected for at least a predetermined amount of time, the navigation device 100 may activate a second mode and may generate a control signal for adjusting the in-vehicle environment to a state corresponding to the second mode in response to the activation of the second mode. In an embodiment, the second mode may be another sub-mode of the infant boarding mode, different from the first mode, and may provide a function for optimizing the vehicle environment when the on-board infant is asleep. The second mode may be referred to as a “sleep mode,” “rest mode,” etc.

In an embodiment, the navigation device 100 may be implemented as at least one computing device. For example, all functions of the navigation device 100 may be implemented on a single computing device, or first and second functions of the navigation device 100 may be implemented on first and second computing devices, respectively. In some embodiments, a specific function of the navigation device 100 may be implemented across multiple computing devices.

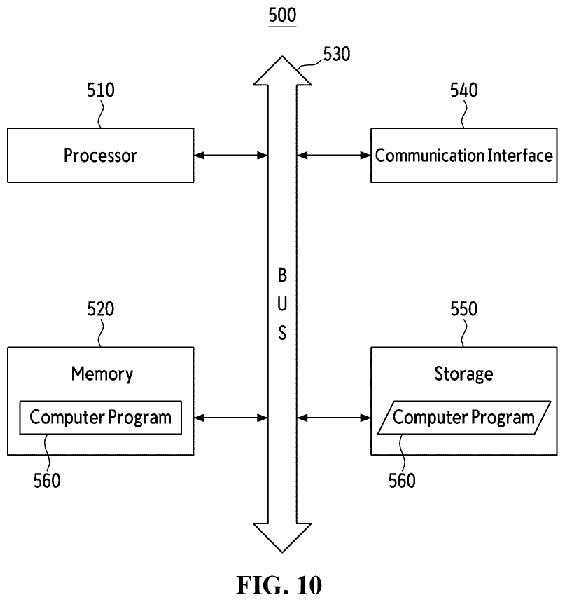

The computing device may include any device having a computing function, and one example of the computing device, according to an embodiment, is illustrated in FIG. 10. Since a computing device is a collection of various components (e.g., memories, processors, etc.) that interact with each other, it may also be referred to as a “computing system.” In addition, a computing system may refer to a collection in which multiple computing devices interact with one another.

In an embodiment, the components illustrated in FIG. 1 may communicate with each other via a network. For example, the network may be implemented as any type of wired or wireless network, such as a local area network (LAN), a wide area network (WAN), a mobile radio communication network, or Wireless Broadband Internet (WiBro). In some embodiments, the navigation device 100 and the mobility device 200 in FIG. 1 may form a single computing system that communicates via the network.

In various embodiments, the configuration of the overall system in which the vehicle environment adjustment method according to some embodiments of the present embodiment may be performed has been described with reference to FIG. 1. The aforementioned embodiments may be understood in greater detail by referring to various embodiments described below. In addition, the technical ideas that can be understood through the above-described embodiment may be reflected in the embodiments described below, even if not explicitly stated.

Methods for adjusting a vehicle environment according to some embodiments of the present disclosure are described in more detail below with reference to FIG. 2 and subsequent drawings. Unless otherwise stated, steps or operations described in each flowchart described below may be understood as being performed by the navigation device 100 described with reference to FIG. 1. However, for convenience of explanation, the subject performing such steps may be omitted from the description.

A method for adjusting a vehicle environment according to an embodiment of the present disclosure is described in more detail with reference to FIG. 2.

FIG. 2 is a flowchart illustrating a method for adjusting a vehicle environment according to an embodiment of the present disclosure. However, this is merely an embodiment for achieving the objectives of the present disclosure, and the present disclosure is not limited thereto. In some embodiments, additional steps or operations may be added or some steps or operations may be omitted, as necessary. In addition, for convenience of explanation, the subject performing each step or operation may be omitted from the description.

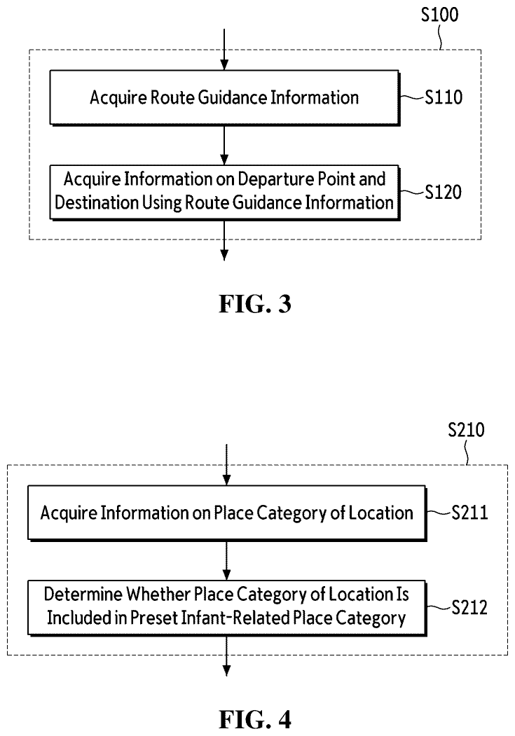

Referring to FIG. 2, the method for adjusting a vehicle environment according to an embodiment of the present embodiment includes a step or operation S100 in which information on a location associated with a vehicle equipped with a navigation device is acquired. The location associated with the vehicle may include a departure point or a destination set in the navigation device. The step or operation of acquiring information on the location, according to an embodiment, is described in more detail below with reference to FIG. 3.

FIG. 3 is a flowchart illustrating the step or operation S100 of FIG. 2 in more detail, according to an embodiment.

Referring to FIG. 3, in order to acquire information on a location associated with the vehicle, route guidance information of the vehicle may be acquired in a step or operation S110. For example, when a user of the vehicle searches for and sets a destination on the navigation device for route guidance, the relevant information may be acquired as route guidance information. In a step or operation S120, departure point information and destination information of the vehicle may be acquired based on the route guidance information. In an embodiment, the departure point of the vehicle may indicate the current location of the vehicle. In some embodiments, only information on the departure point or information on the destination may be acquired.

Referring back to FIG. 2, in a step or operation S200, it may be determined whether an infant is on board the vehicle using the information on the location associated with the vehicle. For example, it may be determined whether the location associated with the vehicle is an infant-related place in a step or operation S210. As a result, if the location associated with the vehicle is determined to be such a place, it may be determined that an infant is on board the vehicle, and if not, it may be determined that an infant is not on board the vehicle. The step or operation of determining whether an infant is on board the vehicle, according to an embodiment, is described in more detail below with reference to FIG. 4.

FIG. 4 is a flowchart illustrating the step or operation S210 of FIG. 2 in more detail, according to an embodiment.

Referring to FIG. 4, in a step or operation S211, information on a place category of the location associated with the vehicle may be acquired. In a step or operation S212, it may be determined whether the place category of the location associated with the vehicle is included in a preset infant-related place category. In other words, if the place category of the location associated with the vehicle is included in the preset infant-related place category, the location associated with the vehicle may be determined to be an infant-related place. Otherwise, the location associated with the vehicle may be determined not to be an infant-related place. In an embodiment, the preset infant-related place category may include at least one of a pediatric clinic, emergency room, daycare center, kids café, kindergarten, children's museum, and children-only theater. However, the present disclosure is not limited thereto, and the infant-related place category may include places for infants or places likely to be visited with infants. In an embodiment, if the location associated with the vehicle is not clearly specified as a specific place, the place category of a nearby place in the vicinity of the location associated with the vehicle may be considered.

Referring back to FIG. 2, in a step or operation S300, in response to determining that an infant is on board the vehicle, the infant boarding mode may be activated for the vehicle. As described above, the infant boarding mode may refer to a function for adjusting the in-vehicle environment for the safety and convenience of the on-board infant.

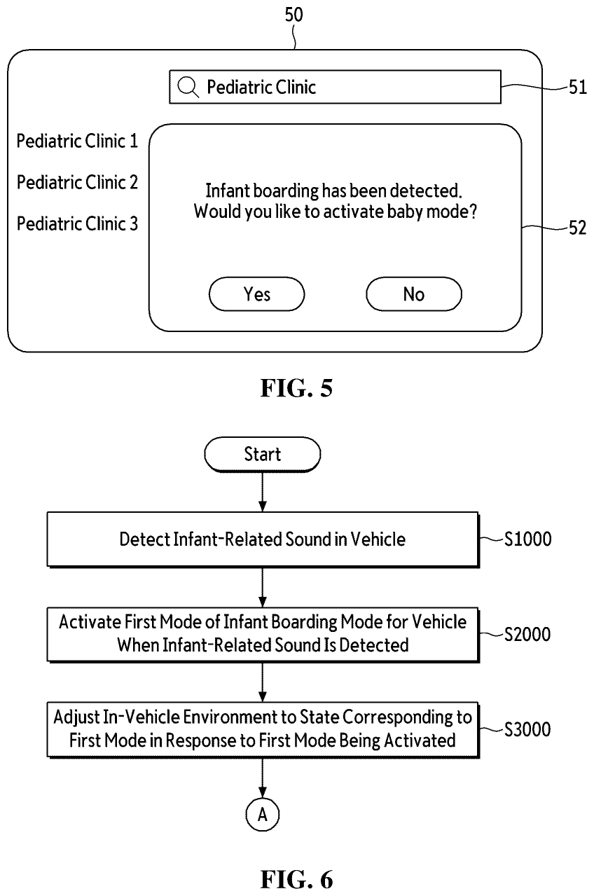

In some embodiments, the step or operation of activating the infant boarding mode, i.e., the step or operation S300, may include providing, on the display of the navigation device, a screen for confirming whether to activate the infant boarding mode. An example screen provided to a navigation device, according to some embodiments, is described in more detail below with reference to FIG. 5.

FIG. 5 is a diagram illustrating an example screen provided to a navigation device according to some embodiments of the present disclosure.

Referring to FIG. 5, when the user of the vehicle inputs and searches for “pediatric clinic” as a destination for route guidance in a search box 51 of the navigation device installed in the vehicle, information on the destination may be acquired as information on a location associated with the vehicle. The destination “pediatric clinic” may be included in a preset infant-related place category, and in this case, it may be determined that an infant is on board the vehicle.

When it is determined that an infant is on board the vehicle, it may be determined whether to activate the infant boarding mode. In this case, a screen 52 for confirming whether to activate the infant boarding mode or a “baby mode” may be provided in the form of a popup on a display 50 of the navigation device. The user of the vehicle may check the screen 52 and select whether to activate the infant boarding mode.

Referring again to FIG. 2, the step or operation S300, in which the infant boarding mode is activated, may include adjusting the settings of the navigation device to correspond to the infant boarding mode. For example, the map theme of the navigation device may be changed to a theme preferred by (e.g., provided for) infants (e.g., characters, animals, toys, etc.). In another example, the voice guidance provided by the navigation device may be changed to a voice preferred by (e.g., provided for) infants (e.g., an animated character's voice).

In some embodiments, when the infant boarding mode is activated, the priority of the route guidance options in the navigation device may be changed. For example, for infant safety, a route that avoids speed bumps or elevated terrain may be recommended as a top priority. In another example, to reduce the time an infant remains in the vehicle, a shortest-time route may be prioritized.

Additionally, as the infant boarding mode is activated, the in-vehicle environment may be adjusted to be optimized for the on-board infant. For example, a temperature control function may be adjusted to maintain a constant temperature inside the vehicle. In another example, a driving mode that minimizes engine noise and vibration may be activated. In yet another example, a child safety lock may be automatically activated to enhance the locking settings of the vehicle doors and windows.

Thus far, the process of adjusting the in-vehicle environment when it is determined that an infant is on board the vehicle has been described in detail with reference to FIGS. 2-5. In various embodiments, it may be determined whether an infant is on board the vehicle using information on the location associated with the vehicle. If it is determined that an infant is on board, the infant boarding mode may be automatically activated, thereby adjusting the in-vehicle environment to be optimized for the on-board infant.

According to the foregoing, since the determination of infant boarding can be made solely based on location information associated with the vehicle, there is no need to install additional complex sensors or multiple devices, and memory and energy efficiency can be greatly improved. Furthermore, since the infant boarding status can be effectively monitored with minimal data, power consumption and memory usage are reduced, contributing to improved energy efficiency of the entire system.

Another embodiment of vehicle environment adjustment is described with reference to FIGS. 6-9. First, a method for adjusting a vehicle environment according to another embodiment of the present disclosure is described in more detail with reference to FIG. 6.

FIG. 6 is a flowchart illustrating a method for adjusting a vehicle environment according to another embodiment of the present disclosure. However, this is merely an embodiment for achieving the objectives of the present disclosure, and the present disclosure is not limited thereto. For example, some steps or operations may be added or omitted as needed, in some embodiments. Additionally, for convenience of explanation, the subject performing each step may be omitted from the description.

Referring to FIG. 6, in a step or operation S1000, an infant-related sound may be detected in real time inside a vehicle equipped with a navigation device. In an embodiment, the infant-related sound may include crying or whining. To detect such a sound in real time, a microphone system including an in-vehicle sound detection unit may be installed, and an infant-related sound may be detected based on the detection of specific vocal frequencies such as crying or whining.

In a step or operation S2000, when an infant-related sound is detected, a first mode of an infant boarding mode may be activated for the vehicle. As previously described, the first mode of the infant boarding mode may be a sub-mode that provides a function for optimizing the vehicle environment when the on-board infant is active.

In some embodiments, the step or operation S2000, in which the first mode of the infant boarding mode is activated for the vehicle, may include providing a screen on the display of the navigation device to confirm whether to activate the first mode. For this, the example explained with reference to FIG. 5 may be referenced.

In some embodiments, the screen for confirming the activation of the first mode may be provided depending on the driving state of the vehicle. For example, when it is determined that the first mode is to be activated, current driving state information of the vehicle may be acquired, and based on the acquired information, it may be determined whether to provide the screen. For example, if the vehicle is currently in motion, the screen may not be provided. If the vehicle is stationary, the screen may be provided. In other words, if the vehicle is being driven, the first mode may be activated automatically without providing the screen, because operating the screen while driving may pose a safety risk.

In a step or operation S3000, in response to the activation of the first mode, the in-vehicle environment may be adjusted to a state corresponding to the first mode. For example, when the first mode is activated, infant-related media content may be provided inside the vehicle. In an embodiment, a signal may be generated to play infant-related media content (e.g., nursery rhymes, animated videos, etc.) on a display device installed at a specific seat in the vehicle (e.g., a seat predicted or designated for infant use), and as a result, the infant-related media content may be automatically played on the display device.

As previously described, the first mode may be the default mode of the infant boarding mode, and when the infant boarding mode is activated, the first mode may also be automatically activated. In this case, the aforementioned in-vehicle environment optimization functions for the infant boarding mode may also be applied in the first mode.

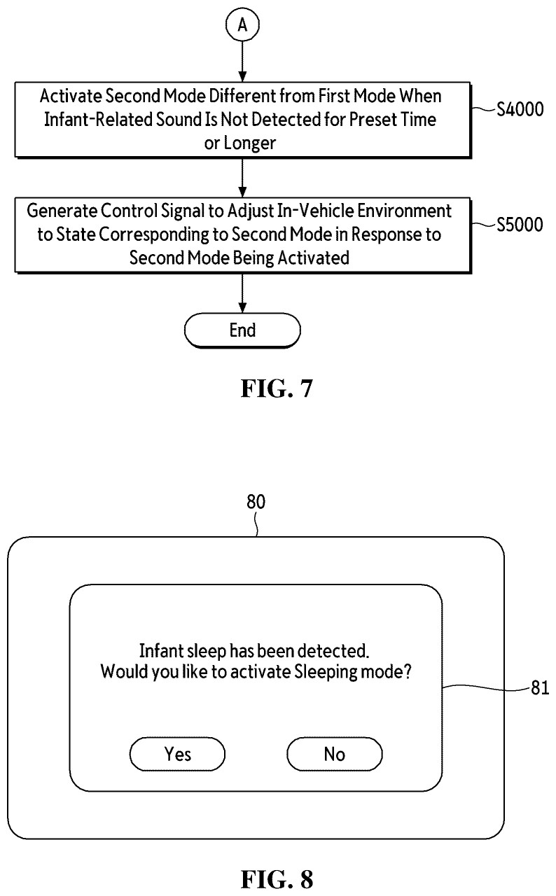

Steps or operations that may follow the step or operation S3000 of FIG. 6, according to some embodiments, are described in more detail below with reference to FIGS. 7-9.

FIG. 7 is a flowchart illustrating subsequent steps or operations that may follow the steps or operations depicted in FIG. 6, according to an embodiment.

Referring to FIG. 7, in a step or operation S4000, if no infant-related sound is detected for at least a predetermined period, a second mode different from the first mode may be activated. For example, if no infant-related sound is detected for a certain amount of time (e.g., 20 minutes), it may be highly likely that the on-board infant is asleep or in a calm state. In this case, the second mode may be activated. In an embodiment, the second mode may be another sub-mode of the infant boarding mode (i.e., different from the first mode) that provides a function for optimizing the vehicle environment when the on-board infant is asleep.

In some embodiments, the step or operation S4000, in which the second mode is activated, may include providing a screen on the display of the navigation device to confirm whether to activate the second mode. An example screen that may be provided to a navigation device, according to some embodiments, is described in more detail below with reference to FIG. 8.

FIG. 8 is a diagram illustrating an example screen provided to a navigation device according to some embodiments of the present disclosure.

Referring to FIG. 8, when it is determined that an infant is asleep inside the vehicle (i.e., no infant-related sound has been detected for a preset period), the second mode may be activated, and a screen 81 for confirming activation of the second mode or a “sleeping mode” may be provided in the form of a popup on a display 80 of the navigation device. The user of the vehicle may check a screen 81 and determine whether to activate the second mode, and the activation of the second mode may be determined based on the user's selection input.

In some embodiments, the screen for confirming the activation of the second mode may be provided depending on the driving state of the vehicle. Specifically, when it is determined that the second mode is to be activated, current driving state information of the vehicle may be acquired, and it may be determined whether to provide the screen based on the acquired current driving state information. For example, if the vehicle is currently driving, the screen may not be provided, and if the vehicle is stationary, the screen may be provided. In other words, if the vehicle is driving, the second mode may be automatically activated without providing a confirmation screen, because operating the screen while driving may pose a safety risk.

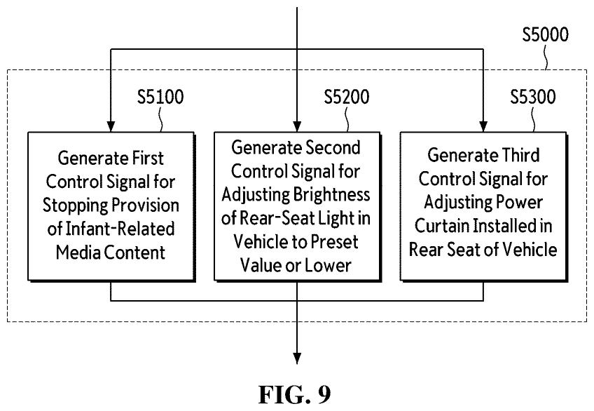

Referring back to FIG. 7, in a step or operation S5000, in response to the activation of the second mode, a control signal may be generated to adjust the in-vehicle environment to a state corresponding to the second mode. The step or operation of adjusting the in-vehicle environment, according to an embodiment, is described in more detail below with reference to the FIG. 9.

FIG. 9 is a flowchart illustrating the step or operation S5000 of FIG. 7, according to an embodiment.

Referring to FIG. 9, in a step or operation S5100, if infant-related media content is being provided inside the vehicle, a first control signal may be generated to stop providing the infant-related media content. Specifically, when the second mode is activated, it may be determined whether infant-related media content is currently being provided or played on a display device installed at a specific seat in the vehicle. If the infant-related media content is determined to be playing, a first control signal may be generated to stop the provision of the infant-related media content. In other words, the provision of the infant-related media content may be automatically stopped.

In a step or operation S5200, a second control signal may be generated to adjust the brightness of the rear seat lighting of the vehicle to a preset value or lower. For example, the rear seat lighting may be dimmed to suit the on-board infant's sleep environment. In this case, the brightness may be automatically adjusted not only based on the preset value but also in consideration of current weather and time conditions. For example, during bright daytime, the lighting may be further dimmed to reduce surrounding brightness, while in the evening or on cloudy days, the lighting may be kept slightly brighter to provide a sense of comfort for the on-board infant.

In a step or operation S5300, a third control signal may be generated to adjust the power curtain installed in the rear seat of the vehicle. Accordingly, the power curtain of the rear seat may be adjusted to suit the on-board infant's sleep environment. In this case, the power curtain may also be automatically adjusted based on current weather and time conditions. For example, during sunny daytime, the power curtain may be adjusted to fully close.

Steps or operations for adjusting the in-vehicle environment according to the state of an infant in the vehicle, according to some embodiments, have been described in detail with reference to FIGS. 6-9. Specifically, when infant-related sound is detected, it may be determined that the on-board infant is active, in which case, the first mode may be activated so that the in-vehicle environment is automatically adjusted to suit an active environment. Also, if no infant-related sound is detected for a certain amount of time, it may be determined that the on-board infant is asleep, in which case, the second mode may be activated to adjust the in-vehicle environment accordingly.

According to the foregoing, since the in-vehicle environment is adjusted (e.g., automatically adjusted) based on the onboard infant's state, there is no need for manual operation of the device while driving, thereby greatly enhancing safety. Furthermore, since the on-board infant's state is determined based on detection of sounds such as crying and switches (e.g., automatically switched) between the first and second modes, the vehicle environment can be effectively controlled with simple sound detection. As a result, complex sensors or multiple devices are not required, leading to high memory and energy efficiency, and mechanical load is reduced, maximizing system efficiency.

Hereinafter, an example computing device that may be configured to implement the above-described navigation device 100, according to some embodiments, is described in more detail with reference to FIG. 10.

FIG. 10 is a block diagram illustrating the hardware configuration of a computing device according to some embodiments of the present disclosure.

Referring to FIG. 10, a computing device 500 may include at least one processor 510, a bus 530, a communication interface 540, a memory 520 that loads a computer program 560 executed by the processor 510, and a storage 550 that stores the computer program 560. However, since only components relevant to the embodiments of the present disclosure are illustrated in FIG. 10, one of ordinary skill in the art to which the present disclosure pertains should recognize that other general-purpose components may also be included in addition to the components depicted in FIG. 10. Accordingly, the computing device 500 may include various additional components besides those illustrated in FIG. 10. Additionally, in some embodiments, the computing device 500 may be configured such that some of the components in FIG. 10 are omitted. The components of the computing device 500 are described in more detail as follows.

The processor 510 may control the overall operation of each component of the computing device 500. The processor 510 may include at least one of a central processing unit (CPU), a micro processor unit (MPU), a micro controller unit (MCU), a graphics processing unit (GPU), or any type of processor well known in the relevant technical field of the present disclosure. The processor 510 may also perform computations for at least one application or program for executing operations/methods according to various embodiments of the present disclosure. The computing device 500 may include one or more processors 510.

The memory 520 may store various data, commands, and/or information. The memory 520 may load the computer program 560 (e.g., in the form of computer-readable instructions) from the storage 550 in order to execute the operations/methods according to various embodiments of the present disclosure. The memory 520 may be implemented as volatile memory such as RAM, but the present disclosure is not limited thereto.

The bus 530 may provide communication functionality between the components of the computing device 500. The bus 530 may be implemented as various types of buses, such as an address bus, a data bus, and a control bus.

The communication interface 540 may support wired or wireless internet communication of the computing device 500. Additionally, the communication interface 540 may support various communication methods other than Internet communication. To this end, the communication interface 540 may include a communication module well known in the technical field of the present disclosure.

The storage 550 may non-transitorily store one or more computer programs 560. The storage 550 may include a non-volatile memory such as read-only memory (ROM), erasable programmable ROM (EPROM), electrically erasable programmable ROM (EEPROM), flash memory, a hard disk, a removable disk, or any form of computer-readable recording medium well known in the technical field of the present disclosure.

The computer program 560, when loaded into the memory 520, may include one or more instructions that cause the processor 510 to perform the operations/methods according to various embodiments of the present disclosure. In other words, by executing the loaded one or more instructions, the processor 510 may perform the operations/methods according to various embodiments of the present disclosure.

For example, the computer program 560 may include instructions for performing the operations of: acquiring information on a location associated with a vehicle equipped with a navigation device; determining whether an infant is on board the vehicle based on the information on the location associated with the vehicle; and activating an infant boarding mode for the vehicle in response to an infant being determined to be on board the vehicle. Here, the determining of whether an infant is on board the vehicle may include determining whether the location associated with the vehicle is an infant-related place.

In another example, the computer program 560 may include instructions for performing the operations of: detecting an infant-related sound inside a vehicle equipped with a navigation device; activating a first mode of an infant boarding mode for the vehicle in response to the detection of an infant-related sound; and adjusting the in-vehicle environment to a state corresponding to the first mode in response to the activation of the first mode.

In yet another example, the computer program 560 may include instructions for performing at least some of the steps/operations/methods described with reference to FIGS. 1-9.

In some embodiments, the computing device 500 illustrated in FIG. 10 may refer to a virtual machine implemented based on cloud technology. For example, the computing device 1000 may be a virtual machine operating on one or more physical servers included in a server farm. In this case, at least some of the processor 510, the memory 520, and the storage 550 illustrated in FIG. 10 may be implemented as virtual hardware, and the communication interface 540 may also be implemented as a virtualized networking element such as a virtual switch.

Various embodiments of the present disclosure and the effects according to embodiments thereof have been described with reference to FIGS. 1-10. The effects according to the technical idea of the present disclosure are not limited to the forementioned effects. Other unmentioned effects should be more clearly understood by those having ordinary skill in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

Although the present disclosure has been described above with reference to several embodiments, those having ordinary skill in the art should appreciate that variations and modifications can be made to the described embodiments without substantially departing from the principles of the present disclosure. Therefore, the described embodiments of the present disclosure are provided in a generic and descriptive sense only and not for purposes of limitation.

What is claimed is:

1. A method for adjusting a vehicle environment, performed by a navigation device, the method comprising:
acquiring information on a location associated with a vehicle in which the navigation device is provided;
determining whether an infant is on board the vehicle based on the information on the location associated with the vehicle; and
in response to determining that an infant is on board the vehicle, activating an infant boarding mode for the vehicle,
wherein determining whether an infant is on board the vehicle includes determining whether the location associated with the vehicle is an infant-related place.

2. The method of claim 1, wherein:
the location associated with the vehicle includes a destination of the vehicle; and
acquiring the information on the location associated with the vehicle includes acquiring information on the destination of the vehicle using route guidance information of the vehicle.

3. The method of claim 1, wherein:
the location associated with the vehicle includes a departure point of the vehicle; and
acquiring the information on the location associated with the vehicle comprises acquiring information on the departure point of the vehicle using route guidance information of the vehicle.

4. The method of claim 1, wherein determining whether the location is an infant-related place includes:
acquiring information on a place category of the location associated with the vehicle; and
determining whether the place category of the location associated with the vehicle is included in a preset infant-related place category.

5. The method of claim 4, wherein the preset infant-related place category includes at least one of a pediatric clinic, emergency room, daycare center, kids café, kindergarten, children's museum, or children-only theater.

6. The method of claim 1, wherein activating the infant boarding mode includes providing, on a display of the navigation device, a screen for confirming whether to activate the infant boarding mode.

7. The method of claim 1, wherein activating the infant boarding mode includes adjusting settings of the navigation device to correspond to the infant boarding mode.

8. The method of claim 7, wherein adjusting the settings of the navigation device includes changing a map theme of the navigation device to a map theme provided for infants.

9. The method of claim 7, wherein adjusting the settings of the navigation device includes changing a priority of route guidance options of the navigation device.

10. A method for adjusting a vehicle environment, performed by a navigation device, the method comprising:
detecting an infant-related sound in a vehicle in which the navigation device is provided;
activating a first mode of an infant boarding mode for the vehicle based on detecting the infant-related sound; and
in response to the first mode being activated, adjusting an in-vehicle environment to a state corresponding to the first mode.

11. The method of claim 10, wherein activating the first mode includes providing, on a display of the navigation device, a screen for confirming whether to activate the first mode.

12. The method of claim 11, wherein providing the screen includes:
acquiring driving state information of the vehicle; and
determining whether to provide the screen based on the driving state information of the vehicle.

13. The method of claim 10, wherein adjusting the in-vehicle environment includes providing infant-related media content in the vehicle.

14. The method of claim 10, further comprising:
activating a second mode different from the first mode when the infant-related sound is not detected for a preset period of time; and
in response to the second mode being activated, generating a control signal for adjusting the in-vehicle environment to a state corresponding to the second mode.

15. The method of claim 14, wherein activating the second mode includes providing, on a display of the navigation device, a screen for confirming whether to activate the second mode.

16. The method of claim 15, wherein providing the screen includes:
acquiring driving state information of the vehicle; and
determining whether to provide the screen based on the driving state information of the vehicle.

17. The method of claim 14, wherein generating the control signal includes generating a first control signal for stopping provision of infant-related media content when the infant-related media content is being provided in the vehicle.

18. The method of claim 14, wherein generating the control signal includes generating a second control signal for adjusting a brightness level of a rear-seat light in the vehicle to a preset value or lower.

19. The method of claim 14, wherein generating the control signal includes generating a third control signal for adjusting a power curtain installed in a rear seat of the vehicle.

20. A navigation device comprising:
a processor; and
a memory configured to store computer-readable instruction that, when executed by the processor, cause the processor to:
acquire information on a location associated with a vehicle in which the navigation device is provided,
determine whether an infant is on board the vehicle based on the information on the location associated with the vehicle; and
in response to determining that an infant is on board the vehicle, activate an infant boarding mode for the vehicle,
wherein determining whether an infant is on board the vehicle includes determining whether the location associated with the vehicle is an infant-related place.

21. A navigation device comprising:
a processor; and
a memory configured to store computer-readable instructions that instructions, when executed by the processor, cause the processor to:
detect an infant-related sound in a vehicle in which the navigation device is provided,
activate a first mode of an infant boarding mode for the vehicle based on detecting the infant-related sound; and
in response to the first mode being activated, adjust an in-vehicle environment to a state corresponding to the first mode.
